(19) United States
(12) Patent Application Publication
(10) Pub. No.: US 2004/0015687 A1
(43) Pub. Date: Jan. 22, 2004

(54) Dual level encrypted cache for secure document print on demand

(76) Inventors: Luca Chiarabini, San Diego, CA (US); Manuel Gonzales, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/333,178

(22) PCT Filed: Jul. 19, 2001
(86) PCT No.: PCT/EP01/08318

(51) Int. Cl. H04L 9/00

(52) U.S. Cl. 713/153; 380/246

(57) ABSTRACT

An on-line disc printing network comprises a portal computer, a print manager computer 301 and at least one print service provider computer 302. The portal computer 300 and print merchant computer 301 are connected by a relatively high bit rate capacity communications link 302. The print merchant computer and print service provider computer 303 are connected by a conventional low bit rate capacity communications link 304, e.g. a 25 kilobits per second modem. The print manager computer and print service provide r computer have respective first and second level cache data storage devices for storage of encrypted content data transferred from the portal to the print manager computer to the print service provider computer. Local storage of encrypted content data at the first and second level cache devices reduces the need for transmission of high volumes of content data over the communications links. Encryption of the content data is maintained throughout the communications up until a final printer device 309 which has decryption capability, thereby ensuring security of content data from portal to printer device.

### FIELD OF THE INVENTION

The present Invention relates to the field of document handling, and particularly although not exclusively, to a method and apparatus for enabling an improved e-printing service incorporating a novel document handling system.

### BACKGROUND OF THE INVENTION

Conventional print on demand services for the production of print products such as large format posters, architectural drawings, leaflets, and the like, have relied on magneto-optical storage systems for the transport of document files containing image data. More recently, document files containing image data have been transported via the internet. One example of an e-printing service which uses a standard web browser interface to offer order creation, processing and invoicing of digital printing jobs can be found at www.mediaflex.com.

However, the internet has severe bandwidth and security limitations which make it difficult to use the internet for transferring high volume or valuable documents. Typically, an originator of a document to be printed has to upload the document onto the internet. A print service provider producing the document, has to download the document from the internet in order to produce print products from the document. Large file sizes, high volumes and limited internet bandwidth restrict the usefulness of such an approach. Further, during the internet transfer process, documents are exposed to non-secure paths and are vulnerable to copying or diversion to third parties. At the print service provider, valuable document content is exposed to human operators of the print service provider, and an originator of the document must trust the print service provider, often without having checked out the security provisions within the print service provider.

Several prior art solutions have been developed in the past concerning caching systems. However, none of these provides a dual level caching system for upload and download, nor offers a complete origin-to destination secure transfer transaction. With prior art technologies, documents are exposed to unauthorized usage during either transmission or production of prints, without control throughout the whole transmission path for content data. For example, most prior art web browsers include a caching system which optimizes internet bandwidth for downloading data, but not for uploading data. They handle secure content transfer through encryption, but do not handle storage of data securely. Prior art web browsers work around this problem by not caching ‘secure’ content data at all.

### SUMMARY OF THE INVENTION

In one specific implementation according to the invention, usage of low bit rate capacity connections is optimized by making use of a compressed and encrypted caching system. The caching system is structured in two levels, a first level cache for uploading of document files, and a second level cache for downloading of document files. The dual level cache eliminates the need to repeatedly upload and/or download items of most requested content to or from a communications network, for example the internet. One level of the dual level cache is present in an internet server which acts as a gateway to the Internet. The internet server obtains content uploads directly from a plurality of portals or websites. Content is uploaded to the gateway server only if not already present in the first level cache at the server, or if a new version of the content is available. The gateway server cache is propagated to a second level server, strictly on demand. Each print service provider has a print manager computer. Only when print service providers are chosen to print a specific content will their print service manager download the content from the gateway server. Otherwise, the content is not downloaded.

Both levels of the caching system use a pull mode for data transfer based on a content identification code. This technique differentiates the specification of the content from the actual transfer of the content data. Through this mechanism, each caching level is entitled to take decisions about whenever to download a specific content or not from the servers with which they correspond.

By always transmitting and storing data in encrypted format, a high degree of protection against inappropriate usage or malicious acts to individual server computers is provided. Since the gateway server has no decryption capability, even if a document is appropriated from a gateway server, it remains encrypted, without the prospect of appropriating an appropriate decryption algorithm at the same time.

According to the first aspect of the present invention there is provided a method of an online distributed printing network comprising a plurality of computer entities communicating over a communications network, said plurality of computer entities comprising:

a portal computer entity (102) capable of receiving orders for print products from a plurality of remote customers;

a print merchant computer entity (100) capable of receiving encrypted content data from said portal computer, said print merchant computer having a first cache device (305) for storage of said content data in encrypted format;

at least one print service provider computer entity (303) capable of communicating with said print merchant computer entity, said print service provider computer having a second cache (306) for storage of encrypted content data; and

at least one printer device (307-309) capable of printing print products incorporating said content data.

According to a second aspect of the present invention as provided in method of operating a print merchant computer entity comprising a processor, and a cache data storage device, said method comprising the steps of:

receiving an encrypted content data;

storing said encrypted content data in said cache device;

in response to a received request for said content data; checking whether said content data is stored in said cache;

if said content data is stored in said cache, retrieving said encrypted content data; and

transmitting said encrypted content data.

According to a third aspect of the present invention there is provided a method of operating a print service provider computer, said print service provider computer comprising a processor and a second cache data storage device, said method comprising the steps of:

a specification data identifying a content data;

checking whether a content data corresponding to said specification data is already stored in said second cache device;

if said specified content data is stored in said second cache device, retrieving said encrypted content data; and

transmitting said encrypted content data to a printer device.

According to a fourth aspect of the present invention there is provided a print merchant computer entity comprising a processor and a cache data storage device, said print merchant computer comprising:

means for receiving an encrypted content data;

means for checking whether said content data is stored in said cache;

means for retrieving said encrypted content data from said cache; and

means for transmitting encrypted content data.

According to a fifth aspect of the present invention there is provided a print service provider computer comprising at least one processor, and a second cache data storage device, said computer further comprising:

means for receiving a specification data identifying a content data;

means for checking whether a content data corresponding to said specification data is already stored in said second cache device;

means for retrieving said content data from said second cache device; and

means for transmitting said content data.

### BRIEF DESCRIPTION OF THE DRAWINGS

For a better understanding of the invention and to show how the same may be carried Into effect, there will now be described by way of example only, specific embodiments, methods and processes according to the present invention with reference to the accompanying drawings in which:

FIG. 1 illustrates schematically an on-line distributed printing network for providing efficient print services to a plurality of customers;

FIG. 2 illustrates schematically a physical view of part of an internet enabled print service provider business according to a specific implementation of the present invention;

FIG. 3 illustrates schematically a logical layout of part of the on-line distributed printing network for supplying secure transmission of data between computer entities over the internet, and for optimizing usage of bit rate capacity over communications links;

FIG. 4 illustrates schematically a purging algorithm for purging data from a cache of the online distributed printing network;

FIG. 5 illustrates schematically messaging and data transfer between computer entities comprising the online distributed print network of FIG. 1;

FIG. 6 illustrates schematically a method of operation of a portal computer for receiving customer orders for print products, by passing them to a print merchant computer;

FIG. 7 illustrates schematically a first mode of operation of a print merchant computer for passing on orders for print products to a print service provider, for satisfaction of that order by production of printed products;

FIG. 8 illustrates schematically a mode of operation of a print service provider computer for receiving an order for printed products, and for satisfying that order by printing of image content on a physical printer device;

FIG. 9 illustrates schematically a second method of operation of the print merchant computer for supplying and/or obtaining content image data in encrypted format, upon receipt of a request for content data received from a print service provider computer;

FIG. 10 illustrates schematically a mode of operation of print merchant computer and/or the print service provider computer for purging out-of-date content data from a cache of said print merchant or print service provider computer respectively; and

FIG. 11 illustrates schematically another mode of operation of a print service provider computer for handling decryption of encrypted image content data in a secure manner, for printing authorized images, whilst minimizing the risk of unauthorized image content being printed.

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

Whilst the following description applies to a plurality of computer entities communicating over the internet, it will be understood by the person skilled in the art, that in general such entities may communicate over any communications network, including virtual private networks (VPN's), local area networks (LAN's), mobile telecommunications networks or the like.

In this specification, the term ‘on-line’ used in the context of computer entities or businesses, means a computer entity or business as appropriate, which can send and/or receive products and/or services in the form of electronic data over a communications network. The computer entity and/or business may also be capable of carrying out transactions over the communications link, in the form of exchanges of electronic data with other computer entities or businesses, over the communications network.

In this specification, the term ‘communications network’ includes any communications network over which a plurality of computer entities can communicate with each other by transfer of electronic data files. Such networks include both packet switched and circuit switched networks, and hybrids of packet switched/circuit switched networks. Examples of such networks include the internet, wide area networks (WAN's). Various protocols such as internet protocol (IP); asynchronous transfer mode (ATM); wireless application protocol (WAP) and the like may be used.

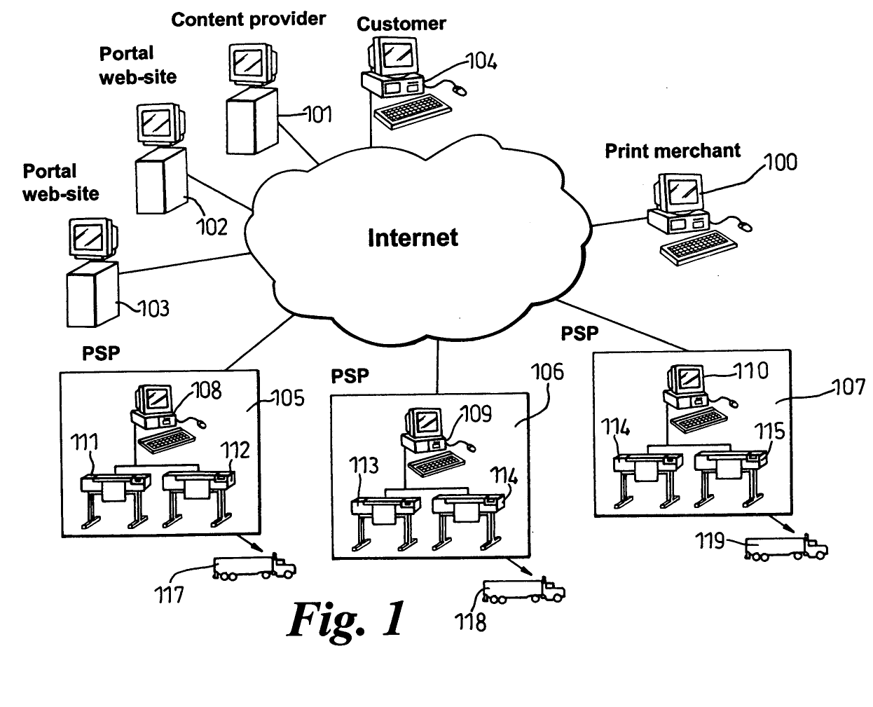

Referring to FIG. 1 herein, there is illustrated schematically a physical architecture of an on-line distributed printing network for providing printing services to a plurality of customer terminals 104, in response to a plurality of orders from customers, who may also be the end users. The network comprises a plurality of internet-enabled print service providers 105-107 each capable of providing physical prints in response to orders for printed images; an internet-enabled print merchant computer entity 100 for matching a plurality of orders for print services to the plurality of print service providers 105-107; one or a plurality of internet-enabled content provider computer entities 101 capable of providing image data; a plurality of portal computer entities 102, 103, each capable of receiving orders from subscribers, e.g. the general public, for printed images; and one or a plurality of courier service providers 117-119 acting to deliver physical prints to specified end users.

Individual internet-enabled businesses utilize different types of computer entity as follows:

A portal business, has a portal computer entity 102, 103 and may provide image content on-line to customers by offering such content via a website. The customers, usually direct retail customers e.g. members of the public, using personal computers having web browsers may view web pages made available at the portal computer entity, and may order on-line prints of those images, using a known web site e-commerce engine for handling payment details.

A content provider business has a content provider computer entity 101, storing a plurality of image data, of interest to individuals and businesses and deliverable on-line. For example, a content provider business may provide a library of pictures, in data format, stored in a database and made accessible over the internet by a content provider computer entity 101.

A print merchant business, has a print merchant computer entity 100, and provides a service to business customers, direct retail customers, content retailer websites and content providers, as well as to one or more print service providers. For the content retailer business, the print merchant allows conversion of orders from subscribers to those portal business into high quality prints which can be sold by the portal websites, with reliability of print and delivery to end users. For the portal website, the print merchant business offers the proposition to convert their image content into high quality posters which the portal website can sell direct to their on-line customers. The print merchant business handles the printing and delivery service for the portal business with reliability. For the print service providers, the print merchant offers capture of printing demand to keep the print service providers busy and provides assistance in managing workflow automatically to the print service provider. Print service providers are connected to print manager 100 by their print manager computers, which act as e-servers 108-110. Each e-server allows a plurality of printing devices 111-116 to be connected to the print merchant. For the print service providers, the print merchant business offers the proposition of capturing printing demand, particularly large format printing demand for the print service providers, and providing the equipment to help the print service provider manage a print on-demand printing service to fulfil the demand, managing workflow automatically within the print service providers operation, and minimizing manual intervention.

A print service provider business comprises an on-line enabled print service provider computer entity 108-110, and one or a plurality of printer devices 111-116, the print service provider computer entity capable of receiving orders from the print merchant computer entity on-line, e.g. over the internet, and capable of receiving on-line image data direct from the content provider computer entity, portal entity, or print merchant entity.

As will be understood by those skilled in the art, each computer entity comprises at least one processor, at least one communications support, and an associated memory. Each computer operates in accordance with pre-set algorithms written in a conventional programming language, which comprise means for carrying out those modes for operation and functions, as will be understood by those skilled in the art.

Individual customer computer entities connect to the internet in known manner using, for example, a modem, ISDN line, or the like. It will be appreciated by those skilled in the art that whilst communications between computer entities have been described as being over the TCP/IP internet, in the best mode, the invention is not restricted to such means of communications, but may make use of any suitable communications network or a mixture of network links, including, but not limited to, virtual private networks (VPN's), local area networks (LAN's), wide area networks (WAN's), using any suitable routing and/or transport protocols.

A customer terminal 104 may include any computer entity capable of sending an order for print products or print services to a print merchant business or a portal business. Customer terminals may be categorized into two basic types: firstly, those without the facility to directly order print products or services from print merchant computer entity 100. Herein after these terminals are referred to as retail customer terminals. Secondly, customer terminals having means for ordering print products or services directly from print merchant computer entity 100 herein after this type of customer terminal will be referred to as a business customer terminal. Business customer terminals are enabled to send image data directly over an on-line communication link, e.g. the internet, to print service provider computer 100, as well as give orders for print products and services. Retail customer terminals typically comprise a personal computer or the like, equipped with a web browser as are known in the prior art.

Content provider computer entity 101 comprises a database storing a plurality of digital image content data representing a plurality of images, and an internet compatible communications interface, making available the digital image content data over a communications link.

Print merchant computer entity 100 comprises a server computer capable of communicating on-line with the plurality of print service providers 105-107, one or a plurality of content provider computers 101, one or a plurality of portal computer entity 102,103, one or a plurality of business customer terminals, and optionally one or a plurality of server computers belonging to one or a plurality of respective courier businesses.

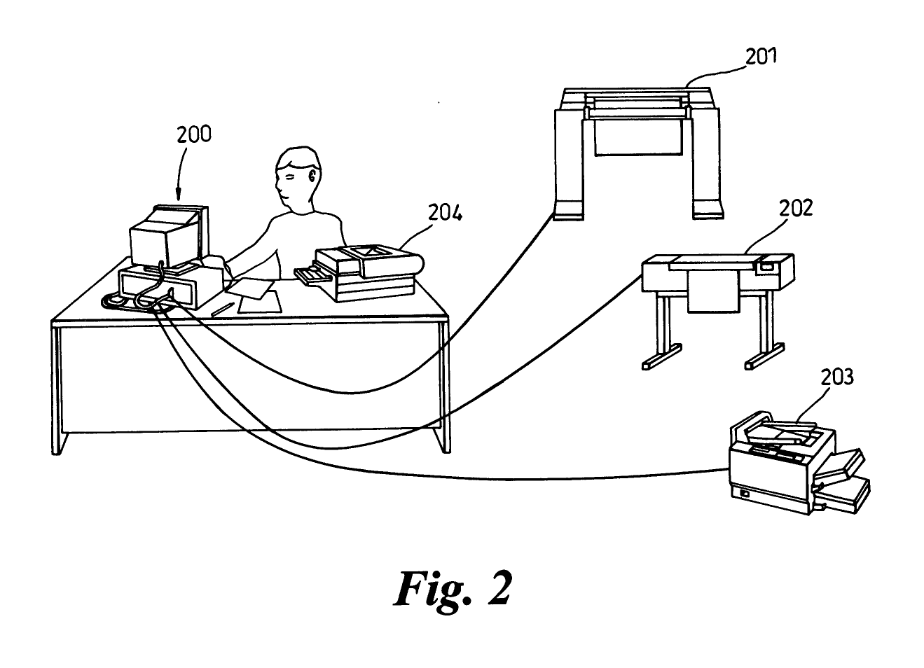

Referring to FIG. 2 herein there is illustrated schematically a view of one example of a print service provider facility 105. Print service provider facility 105 comprises at least one print service provider computer entity 200, one or a plurality of printer devices 201-203 for printing out print products encompassing images received via print service provider computer 200, the plurality of printers printing out under control of the print service provider computer 200 which automatically allocates print jobs to individual printers. Additionally, the print service provider facility comprises a finishing department, not shown in FIG. 2, for applying special finishes to print products, for example lamination, gloss finishes or the like; and a shipping department for packaging orders of print products into packaging, for example roll tubes, boxes or plastics, envelopes.

The plurality of printer devices 201-203 may provide a selection of different printer devices capable of handling different sizes of print media. Each printer device receives instructions for printing of images, as well as image data itself from the print service provider computer 200 according to print order received over the internet by print service provider computer 200. Print service provider computer 200, additionally prints out instructions to human operators, in the form of paper work order sheets and packing slips containing labels, to enable human operators to collect print products from the plurality of printer devices, and to efficiently process the print products through the finishing department and shipping department. The instructions may be printed via a locally connected peripheral printer 204, e.g. a HP LaserJet device or similar.

Printer devices 201-203 may include legacy printer devices which have no capability for decryption of encrypted content data, in which case they must receive content data in unencrypted format. However, individual printer devices 201-203 may include printer devices having in-built decryption capability, enabling the printer devices to receive encrypted content data, and decrypt that data within the printer device prior to printing.

The print service provider computer may support decryption, but in a limited and controlled way. Decryption is performed to print with legacy devices, and only for printing purposes. No document ripping is possible at all.

For print devices which support encryption and authentication, the print service provider computer preserves the content data in encrypted format even for printing at the printer device. It also prevents operators within the print service facility from producing unauthorized versions of documents, or making unauthorized copies.

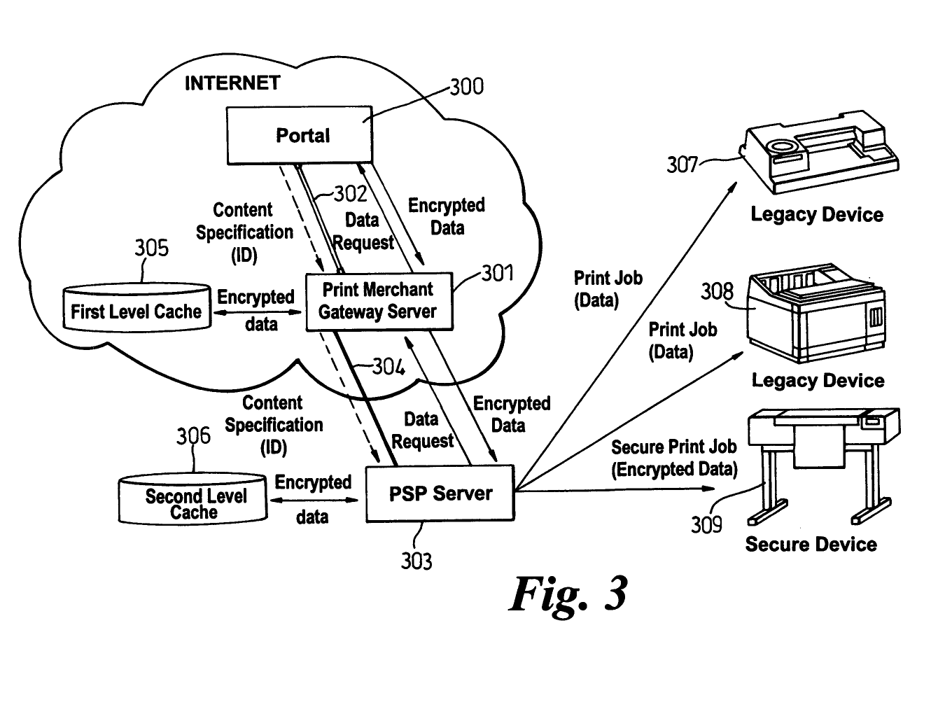

Referring to FIG. 3 herein, there is illustrated schematically a logical architecture of the on-line distributed printing network shown in FIG. 1 herein, illustrating messaging between computer entities, and transfer and storage of content data between computer entities in secure format.

Portal computer entity 300 is connected with print merchant computer entity 301 by means of a high bit rate capacity backbone link of bit rate capacity more than 56 kilobits/s. The print merchant computer 301 acts as a gateway server to the internet, and is connected to each of the PSP servers 304 by means of conventional internet connections, typically being a low bit rate capacity link, or example 10 to 20 kilobits per second link 304. Print merchant gateway server 301 is provider with a first level cache data storage device 305, whilst print service provider computer 303 is provided with a high capacity second level cache data storage device 306. Even though the portal computer entity 300 is connected to the print merchant gateway server 301 by a high bit rate capacity link, the first level cache 305 is provided to avoid overstressing the download capacity of the portal computer 300.

The portal to print merchant gateway connection 302 overcomes the bit rate capacity problem by provision of a high bit rate capacity link 302. The print merchant gateway server to print service provider server connection 304 overcomes the low bit rate capacity limitation of the link 304 by use of the second level cache to minimize the transfer of data between the print merchant gateway server and the print service provider server.

Data stored in the first level cache is stored in encrypted format. Therefore, if unauthorized access to the first level cache is obtained, and data removed, the data will be removed in encrypted format. Since the print merchant gateway server does not contain any decryption facility, the print merchant gateway server cannot be compromised by obtaining encrypted data together with a decryption algorithm or a decryption key which could be used to decrypt the encrypted data. The print merchant gateway does however contain encryption algorithms, used for encrypting data received in unencrypted format from any of the portals.

The caching system also allows a ‘pre-load’ mechanism. Content expected to be highly requested in the near future, for example at Christmas or Valentine's Day etc. can be sent in CD-ROM, or DVD-ROM format to human operations of the print merchant gateway server or print service provider computer. The print merchant gateway server or PSP server operators, having inserted a CD-ROM, DVD-ROM in their server systems will automatically and transparently integrate the given contents into the corresponding caching system. No internet download will be required for all such highly requested content.

The caching system is driven by dedicated disk capacity. Under exceeded maximum capacity or near out of disk space condition, the cache system automatically purges itself by disregarding oldest content that has not been printed for a long period, for example days or weeks. Whenever the purged content is required again, it is automatically retrieved from the first level cache on the content provider, and stored again until expiration.

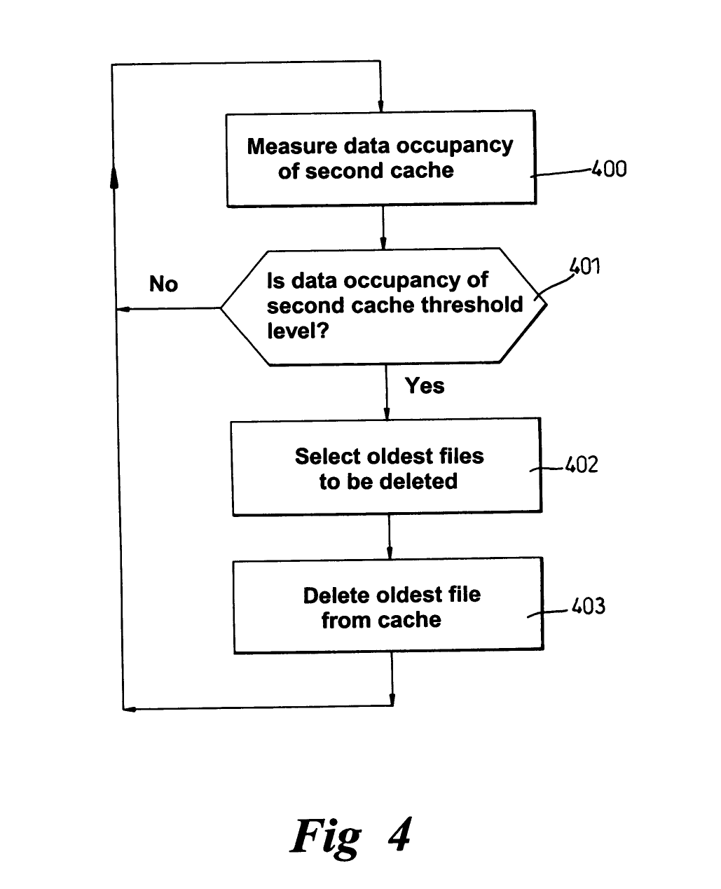

Referring to FIG. 4 herein, In step 400, the data occupancy of the second cache is measured. If, in step 401 the data occupancy of the second cache is above a predetermined threshold level for data occupancy, then in step 402 the oldest file in the second level cache is selected and is deleted in step 403. The data purging algorithm then proceeds back to step 400 to re-measure the data occupancy for the second cache. The steps 400-403 proceed until the data occupancy of the second level cache is below the predetermined threshold value.

The cache system is completely transparent, and all operations related with caching or purging of content data are automatic.

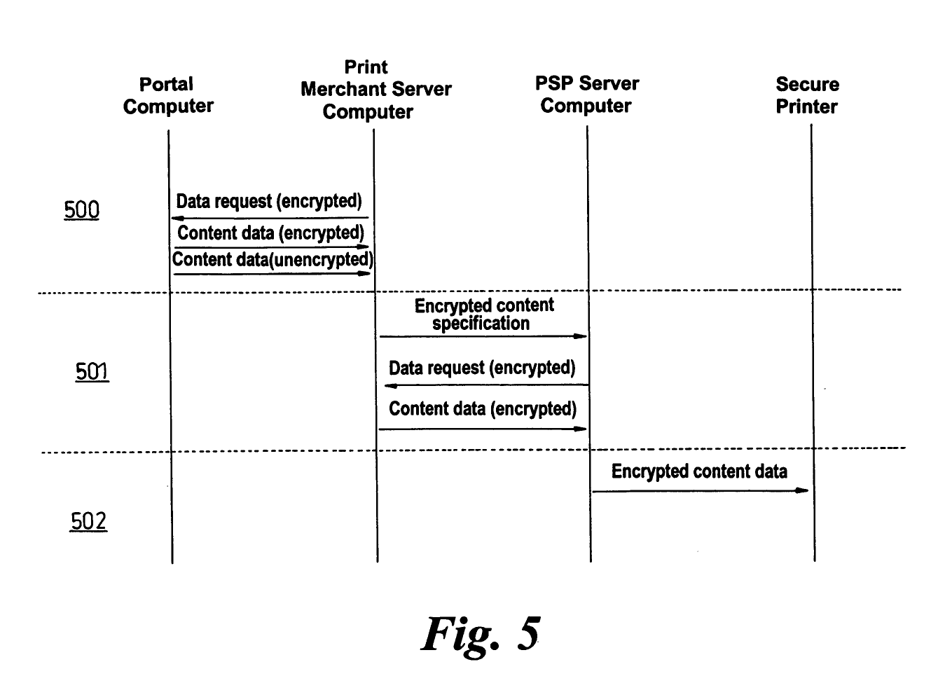

Referring to FIGS. 5 to 8 herein, there will now be described a method of operation of the on-line distributed printing network, for receiving an order for print products from an internet-based customer at portal 300 and satisfying that order by automated production of print products.

Satisfaction of an order is made by 3 main stages including a first stage 400 of communication between a portal computer and a print merchant computer, a second stage 401 of communication between the print merchant computer and a print service provider computer 303, and a third stage 402 of communication between a print service provider computer and a printer device.

In first stage 400, the content data sent from the portal to the print merchant computer can either be in encrypted or unencrypted format If the print merchant computer receives unencrypted content data, then it applies its own encryption to that data, prior to sending the data on to a print service provider computer 303.

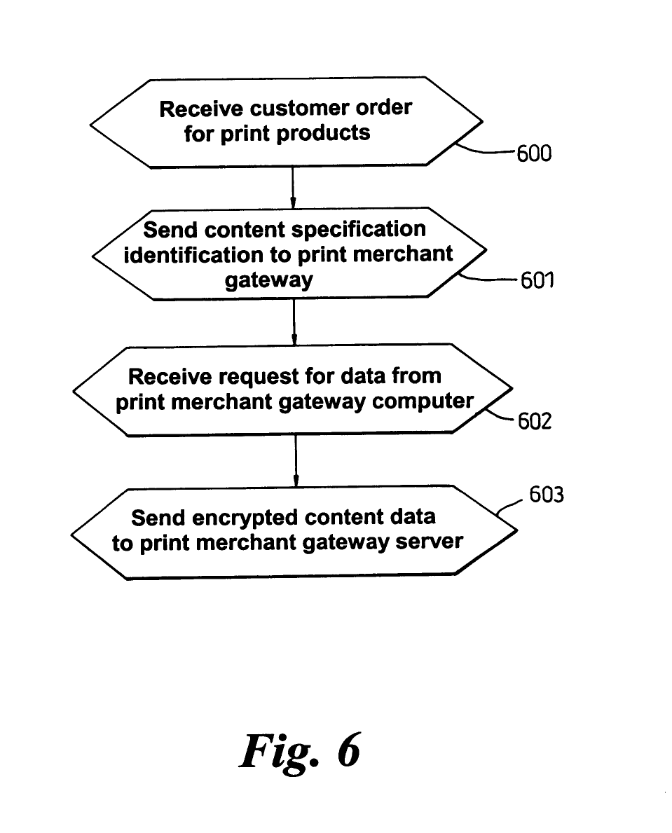

Referring to FIG. 6 herein, in step 600 portal computer 300 receives a customer order for a plurality of print products. Typically, such an order is placed by a customer using a personal computer or similar, operating a web browser and selecting a plurality of print products from a menu or content display generated by a web server at the portal. In step 601 the portal computer sends a content specification identification data to print merchant computer 301. The content specification identification comprises data which uniquely identifies content to be printed. The content may include artwork, architectural drawings, or any other printable matter. In step 602 if the print merchant computer does not already store the content data in its first level cache, then the portal computer receives a request for content data from the print merchant gateway computer. In step 603, if a request for content data is received from the print merchant gateway computer, the portal computer sends the content data to the print merchant gateway computer over the high bit rate capacity link 302.

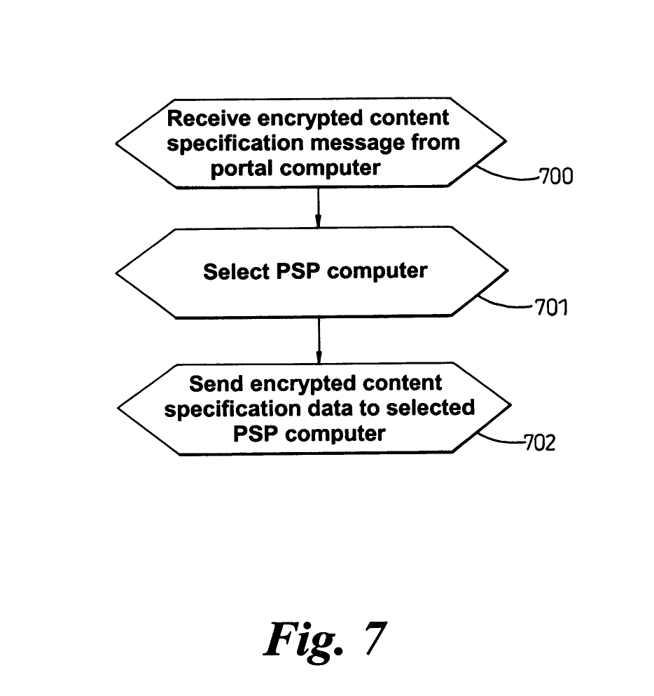

Referring to FIG. 7 herein, there is illustrated schematically a first mode of operation of the print merchant computer 301 on receiving a content specification data from a portal 300. In step 700, the print merchant gateway receives encrypted content specification data from the portal computer 300. In step 701 the print merchant gateway selects a print service provider computer 303. In step 702 the print merchant server sends the encrypted content specification data to the selected print service provider computer 303.

On receiving the content specification identification, the print service provider computer decides whether or not to request data from the print merchant gateway.

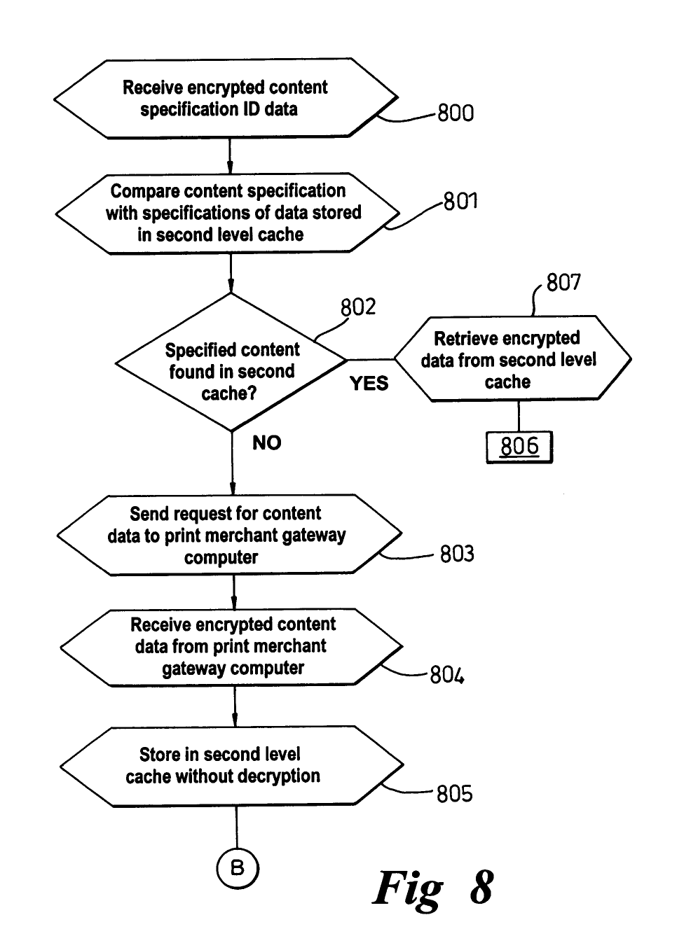

Referring to FIG. 8 herein, there is illustrated schematically a mode of operation of the print service provider computer 303. When an order is received by the print service provider, the order is shown on a screen presented by an application. An operator at the print service provider decides whether or not to accept the order, or alternatively the acceptance/rejection of the order may be automated. In stop 800, the print service provider computer receives encrypted content specification identification data from the print merchant computer 301, over the low bit rate capacity communications link 304. In step 801, the print service provider computer compares the received content specification with specifications of encrypted data already stored in the second level cache 306. Typically, the second level cache 306 may comprise a hard disk drive of capacity of the order 5 to 10 gigabytes. Data is stored in the second level cache in encrypted format. In step 802, if the specified content data is found in the second cache, then the print service provider computer retrieves the encrypted data from the second level cache in step 807, and in step 806 selects one or a plurality of printer devices. In a full implementation according to the present invention, all printer devices support decryption of content data at the printer device, so that communication between the print service provider computer and the printer device can take place in encrypted form and there is no requirement for a decryption algorithm stored in the print service provider computer 303. This avoids human personnel in the print service provider facility decrypting the image content and making electronic copies, e.g. on floppy disk, CD ROM, DVD ROM or the like, of the decrypted content data. If the selected printer does support decryption, then in step 810 the print service provider computer transmits the encrypted data over a non-secure encrypted communications link, e.g. a local area network, or the internet to the selected printer device. On receipt of the encrypted content data, the printer device applied a decryption algorithm stored locally at the printer device to decrypt the content data and then print an image onto a print product according to the decrypted content image data.

However, in a non-optimal implementation, legacy printer devices 307, 308 may be present, which do not support decryption of content data at the printer. Under these circumstances the legacy devices must receive content data in unencrypted format, and there is a requirement for a decryption algorithm within the print service provider computer 303. In these circumstances, in step 808 the print service computer 303 decrypts the content data and in step 809 transmits the decrypted content data to a selected printer device, having no decryption facility. In this case, there is a risk that, because a decryption algorithm is stored in the print service provider computer 303, that a copy of encrypted content data, together with a decryption algorithm, can be appropriated from the print service computer, or that decrypted content data can be obtained from the print service provider computer, by means of physical carrier, e.g. CD ROM or DVD ROM.

If the print service provider computer 303 does not find the specified content in the second level cache 306, then in step 803 the print service provider generates a data request, requesting the content data from the print merchant computer 301, which is sent over the low bandwidth communications link 304. In step 804, the print merchant computer having obtained the requested encrypted content data, the print service provider computer receives the encrypted content data. In step 805, the print service provider computer stores the encrypted content data in the second level cache, without decrypting the content data, and proceeds to step 806.

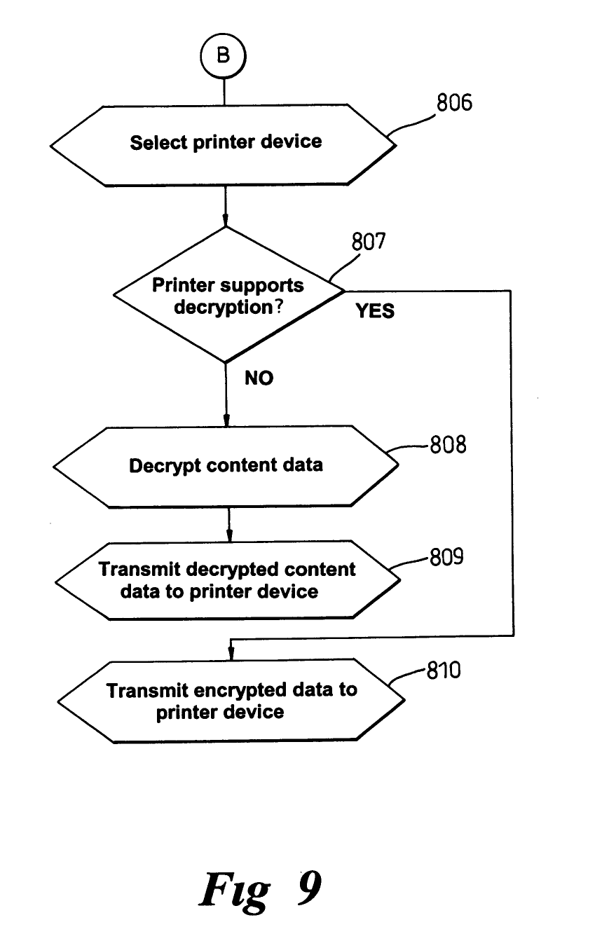

Referring to FIG. 9 herein, there is illustrated schematically a second mode of operation of print merchant computer 301 for providing content data to print service provider computer 303. In step 900, the print merchant computer receives a request for data from the print service provider computer 303 over the low bit rate capacity link 304. In step 901, the print merchant computer compares the content specification, subject of the data request received from the print service provider computer 303 with encrypted content data stored in the first level cache 306. If in step 902 the specified content data is found to be already stored in the first level cache, then in step 906, the print merchant computer retrieves the stored content data in encrypted format from the first level cache 305, and sends it to the print service provider computer 303 over the low bit rate communications link 304. However, if the specified content is not available in the first level cache 305, then the print merchant gateway computer 301 must obtain it from the portal 300, and in step 903 generates a data request to the portal computer requesting the specified content data. In step 904, the print merchant computer receives the encrypted content data from the portal computer 300 and in step 905 stores it locally in its first level cache 305 before proceeding to send the encrypted content data to the print service provider in step 906.

Communications between the portal computer 300, print merchant computer 301 and print service provider computer 303 may optimize use of bit rate capacity over the high bit rate communications link and low bit rate communications link 304, since specifications of the content data are transmitted between the portal, print merchant and print service provider computers, without actual transport of the encrypted content image data itself wherever possible.

The print service provider computer 303 checks whether it already has the content data stored in its second level cache, before requesting it from the print merchant computer 301. The print merchant computer 301, upon receiving a request from the print service computer 303 for the content data, checks in its first level cache 305 whether it already has that encrypted content data before requesting it from the portal computer 300.

Further, in the best mode implementation, content data is maintained in encrypted format throughout transmission between the portal computer, print merchant computer and print service provider computer, and remains encrypted even as it arrives at the final printer device 309. Decryption of the content data is carried out only in the printer device in the best mode, and no decryption algorithms are stored in the print service provider computer 303, or the print merchant computer 301, thereby assuring the operator of the portal 300 of data security. Even if the encrypted content data is compromised and appropriated between the portal and print merchant, from the print merchant, or between the print merchant and the print service provider computer, or from the print service provider computer, it will only be available in encrypted format, and no decryption algorithm can be downloaded from the same source. A decryption algorithm must be stored in a local processor of a secure printer device 309 in order to decrypt the image data prior to printing. However, the printer device can be engineered such that appropriation of decryption data is physically difficult from the printer device. Further, the printer device will be typically stored in a physically inaccessible location, e.g. a print room, to which access may be limited to specified personnel.

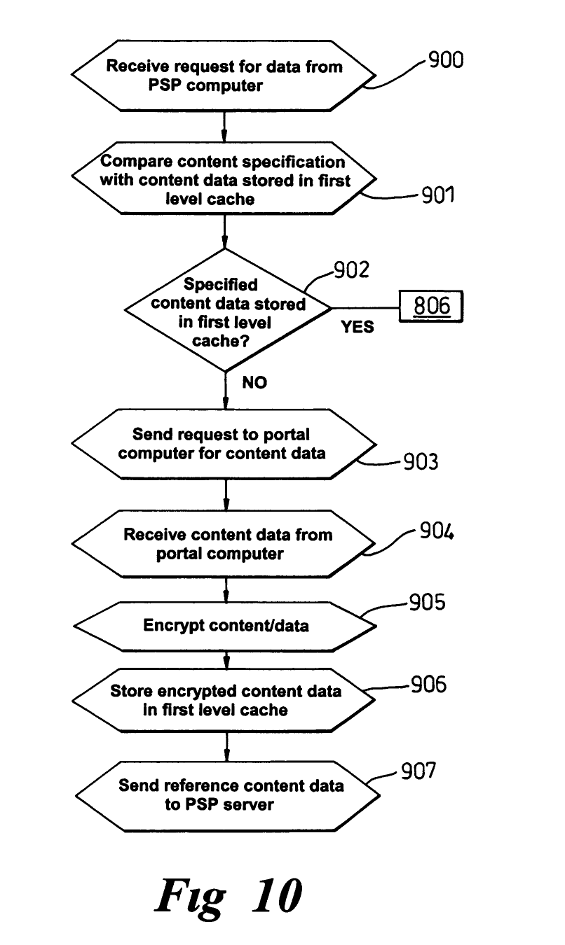

Referring to FIG. 10 herein, there is illustrated schematically a mode of operation applicable to either the print merchant computer 301 and/or the print service provider computer 303 for purging the respective first or second level cache of out of date content data items. The method of operation will be described with reference to the print merchant computer although it will be understood by those skilled in the art that the method of operation applies equally to the print service provider computer. In step 1000 a stored content data item resident in the first level cache 305 If selected. When encrypted content data is stored in the first level cache, it is stored with a time and date data, enabling a vintage and age of the content data to be identified. In step 1001, the date/time data is read. The content date/time data is updated every time the content data is accessed for retrieval by the print merchant computer. On initial storing for the first time of the content data, the date/time data is appended to the data in the first level cache. In step 1002, the print merchant computer determines the time difference between a present time and the last time the encrypted content data was accessed for the purpose of retrieval. If this time difference is less than a predetermined time, which is user settable by an operator of a print merchant computer, then the algorithm proceeds back to step 1000. However, if the content data is older than the predetermined time as a result of step 1002, then in step 1003 the print merchant computer identifies the content data as being able to be overwritten by new content data.

As the print merchant computer receives new content data from the portal 300, and this is stored when received, in order to avoid the first level cache becoming overfull resulting in random overwriting of already stored content data, the purging algorithm of FIG. 10 operates to select the oldest content data, that is to say the content data which has not been used for the longest period, outside a predetermined user selectable period, and assign that content data for overwriting. Purging of the old content data is automatic, and enables the first level cache always to have available space for writing of new content data.

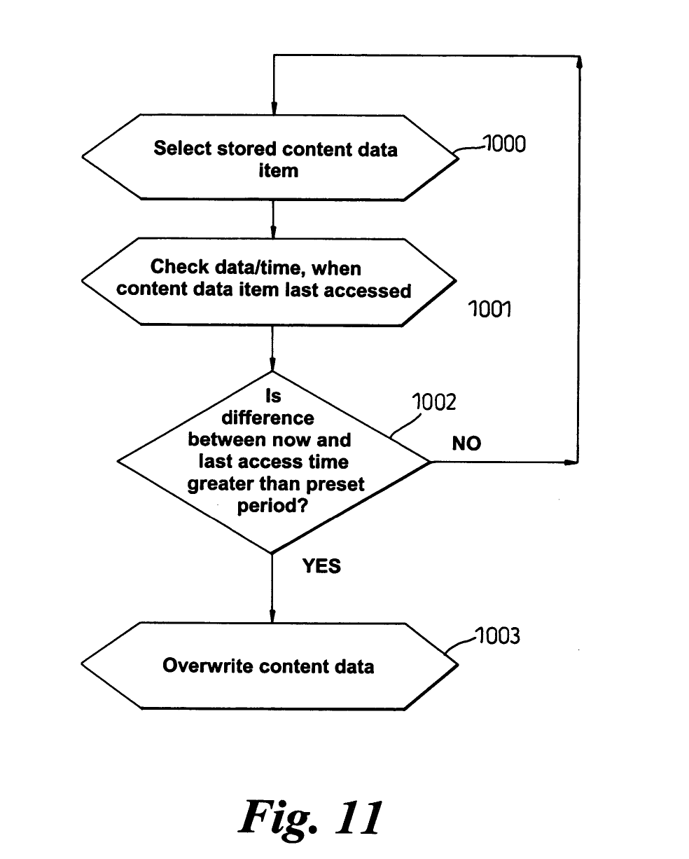

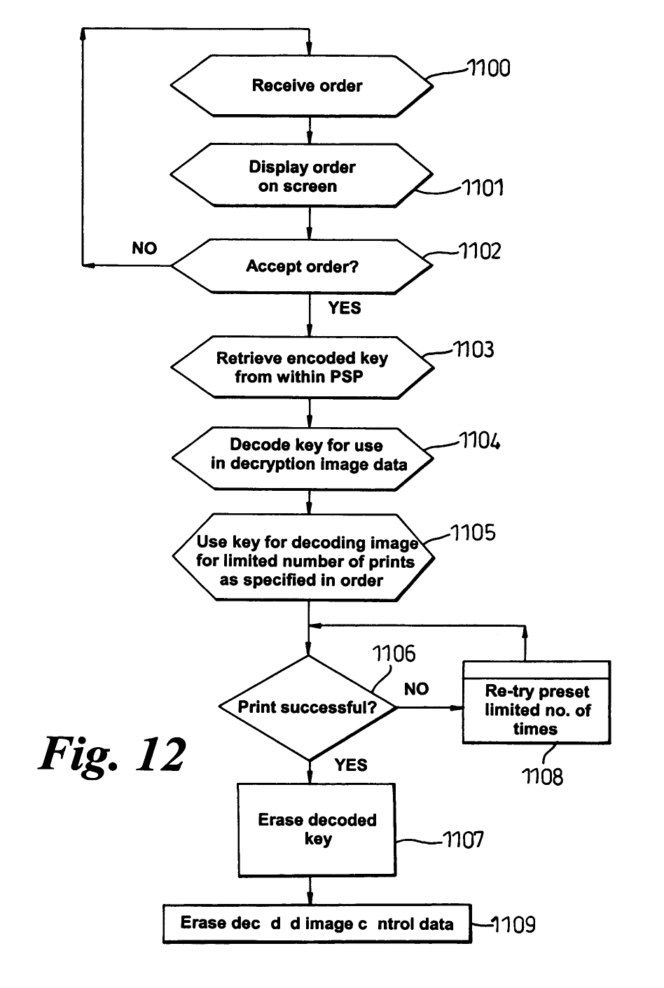

Referring to FIG. 11 herein, there is illustrated schematically operation of the print service provider computer 303 for handling decryption of received encrypted content data. In step 1100, the PSP computer receives an order from the print merchant computer 301. In step 1101, the order is displayed on the screen by an application resident on the print service provider computer. A human operator may accept the order in step 1102, in which case, an acceptance signal is sent back to the print merchant computer. On accepting the order, an application within the print service provider retrieves a locally stored encoded key from within the print service provider. The print service provider application decodes the key, which can be used for decrypting the encrypted content data for a limited number of prints as specified in the order in step 1105. If the specified number of prints are successfully printed in step 1106, by the legacy printers, then the decoded key is erased from the print service provider computer in step 1107. Only the encoded key remains stored at the print service provider computer. However, if printing is not successful, then in step 1108, the application in the print service provider computer allows a limited number of re-tries for printing, before aborting the print operation. If the print operation is aborted, then the decoded key is erased, so that only the encoded key remains stored at the print service provider computer. The encoded key data is provided as part of the print service provider application. The encoded key stored at the print service provider computer is not freely available, and the print service provider computer cannot print any image under control of an operator at the print service provider computer. The application at the print service provider computer limits decoding of the key for usage only in printing images for which an order has been accepted by the print service provider computer, and a number of re-tries for printing, in case of print error is controlled by the print service provider application. Further, no decrypted copies of the image content data are stored at the print service provider computer, as these are erased in step 1109, to protect against re-use of the decoded image data at the print service provider.

1. An on-line distributed printing network comprising a plurality of computer entities communicating over a communications network, said plurality of computer entities comprising:
a portal computer entity (102) capable of receiving orders for print products from a plurality of remote customers;
a print merchant computer entity (100) capable of receiving encrypted content data from said portal computer, said print merchant computer having a first cache device (305) for storage of said content data in encrypted format;
at least one print service provider computer entity (303) capable of communicating with said print merchant computer entity, said print service provider computer having a second cache (306) for storage of encrypted content data; and
at least one printer device (307-309) capable of printing print products incorporating said content data.

2. The on-line distributed printing network as claimed in claim 1, wherein a said printer device comprises:
decryption means for decrypting received encrypted content data within said printer device.

3. The on-line distributed printing network as claimed in claim 1, wherein said print service provider computer comprises decryption means for decrypting received encrypted content data.

4. The on-line distributed printing network as claimed in claim 1, wherein said print service provider computer comprises:
stored encoded key data for decrypting said content data, wherein said stored encoded key data is decoded in response to acceptance of an order from a print merchant computer entity, for decrypting content data of said accepted order only.

5. The on-line distributed print network as claimed in claim 1, wherein said portal computer and said print merchant computer are connected by a relatively high bit rate capacity communications link exceeding 56-k bits/second.

6. The on-line distributed print network as claimed in claim 1, wherein said print merchant computer entity does not store any decryption algorithms capable of decrypting encrypted content data received from said portal computer entity.

7. A method of operating a print merchant computer entity comprising a processor, and a cache data storage device, said method comprising the steps of:
receiving a content data;
storing said content data in said cache device;
in response to a received request for said content data, checking whether said content data is stored in said cache;
if said content data is stored in said cache, retrieving said content data; and
transmitting said content data.

8. The method as claimed in claim 7, further comprising the steps of:
checking said cache for aged content data;
determining whether said aged content data falls inside or outside a predetermined criteria for saving said content data;
if said aged content data falls outside said predetermined condition, then allowing said content data to be purged.

9. A method of operating a print service provider computer, said print service provider computer comprising a processor and a second cache data storage device, said method comprising the steps of:
receiving a specification data identifying a content data;
checking whether a content data corresponding to said specification data is already stored in said second cache device;
if said specified content data is stored in said second cache device, retrieving said content data; and
transmitting said content data to a printer device.

10. The method as claimed in claim 9, further comprising the steps of:
selecting a said printer device;
if said printer device does not support decryption of said content data, decrypting said content data within said print service provider computer and
sending said decrypted content data to said printer device.

11. The method as claimed in claim 10, wherein said step of decrypting said content data within said print service provider computer comprises:
retrieving an encoded key stored within said print service provider computer;
decoding said key for use in decrypting said content data; and
applying said decoded key for decrypting said encrypted content data or a limited number of prints as specified in a received order.

12. The method as claimed in claim 11, further comprising the step of:
erasing said decoded key after printing said predetermined number of prints.

13. The method as claimed in claim 11, further comprising the step of:
erasing said decoded content data after printing a predetermined number of prints specified in said order.

14. The method as claimed in claim 9, further comprising the steps of:
checking said second cache for aged content data;
determining whether said aged content data falls inside or outside a predetermined criteria for saving said content data; and
if said aged content data falls outside said predetermined condition, then allowing said content data to be purged.

15. The method as claimed in claim 9, further comprising the step of:
if said specification data is not stored in said second cache device, retrieving said specified content data in an encrypted form from a print merchant computer entity.

16. The method as claimed in claim 9, further comprising the step of:
if said specification data is not stored in said second cache device, retrieving said specified content data in an encrypted form from a content provider computer entity.

17. A print merchant computer entity comprising a processor and a cache data storage device, said print merchant computer comprising:
means for receiving an encrypted content data;
means for checking whether said content data is stored in said cache;
means for retrieving said encrypted content data from said cache; and
means for transmitting encrypted content data; and
means for encrypting data.

18. The print merchant computer entity as claimed in claim 17, further comprising means for determining whether said aged content data falls inside or outside a pre-determined criteria for saving said content data; and
means for purging said content data from said cache if said aged content data falls outside said pre-determined condition.

19. A print service provider computer comprising at least one processor, and a second cache data storage device, said computer further comprising:
means for receiving specification data identifying a content data;
means for checking whether a content data corresponds to said specification data is already stored in said second cache device;
means for retrieving said content data from said second cache device; and
means for transmitting said content data.

20. The print service provider computer as claimed in claim 19, comprising:
means for checking said second cache for said aged content data; and
means for determining whether said aged content data falls inside or outside a pre-determined criteria for saving said content data.
